(19) United States
(12) Patent Application Publication
(10) Pub. No.: US 2010/0145792 A1
(43) Pub. Date: Jun. 10, 2010

(54) METHOD AND APPARATUS FOR PRESENTING CUSTOMER SPECIFIC VIDEO AND MARKETING MATERIALS

(76) Inventors: William Worthen, Minnetonka, MN (US); Dean Hillesheim, Minnetonka, MN (US); Tim Kost, Farmington, MN (US)

Correspondence Address: MCDERMOTT WILL & EMERY LLP, 600 13TH STREET, N.W., WASHINGTON, DC, 20005-3096, US

(21) Appl. No.: 12/491,750

(22) Filed: Jun. 25, 2009

Related U.S. Application Data
(60) Provisional application No. 61/075,574, filed on Jun. 25, 2008.

(51) Int. Cl. G06Q 30/00; G06Q 10/00; G06F 7/10; G06F 17/30

(52) U.S. Cl. 705/14.42; 705/14.66; 707/723; 707/769; 707/E17.014

(57) ABSTRACT

A computer-implemented method can automatically select a plurality of advertising and/or marketing materials associated with goods and/or services offered for sale via a networked communication system. A networked communication system can be adapted to receive and organize a variety of customer specific, business specific, and general demographic information and can provide a marketing score for each customer known to be present at a commercial establishment. The system can further be adapted to provide a comparison of marketing scores for a plurality of customers and create a video playlist for display in a customer waiting room. The system can include a selectable and adjustable set of marketing parameters that may be adjusted based on one or more relevant considerations. The system can be adapted to determine, based on the marketing scores, advertising and marketing content for display at a commercial establishment.

### PRIORITY CLAIM

The present application claims priority to U.S. Provisional Patent Application No. 61/075,574, entitled “Method and Apparatus for Presenting Customer Specific Video and Marketing Materials,” filed Jun. 25, 2008, the disclosure of which is hereby incorporated by reference in its entirety.

### FIELD OF THE INVENTION

The present invention relates generally to generation and display of advertising and marketing materials. More particularly, the present invention relates to a method and apparatus for customer specific generation and/or display of advertising materials at commercial or retail establishments.

### BACKGROUND OF THE INVENTION

Advertising and marketing are extremely important to any sales based industry. One significant challenge inherent in advertising and marketing of products and/or services is to cater advertising and marketing materials to particular consumers, i.e. directing the materials to someone who is likely willing to purchase offered products and/or services.

One method that is used to cater marketing materials to particular potential consumers is to provide such materials to consumers that are already present at a particular location such as a commercial establishment. A customer of a commercial establishment is typically more likely to purchase products and/or services that are generally similar or related to those that brought the customer to the commercial establishment in the first place. For example, many commercial establishments deploy visual or audio advertisements in order to attract customers to a particular item. Many commercial establishments also deploy marketing materials such as coupons. Often, advertising and marketing materials are provided to potential consumers using one or more displays.

One place where such methods are utilized is in customer waiting rooms. Customer waiting rooms are an ideal place to provide advertising and/or marketing materials because the audience for the materials is generally waiting for an extended period of time with little or nothing else to capture their attention. One problem with providing advertising or marketing materials to a customer a business may not be able to cater displayed materials to goods and/or services in a manner specific to a particular customer. Therefore, a need exists to provide customer specific advertising and marketing materials. A further need exists to provide customer specific materials in an automated or semi-automated and efficient fashion.

### SUMMARY OF THE INVENTION

In one embodiment, a computer based system adapted to create and display customer specific advertising content on-site to customers of a commercial business is disclosed herein. The system may include an advertising management system. The advertising management system can be adapted to receive and organize a plurality of customer specific, demographic, and business or product specific information relating to a particular customer or business. The advertising management system may be adapted to compare the received information to a plurality of marketing profiles in order to determine a marketing profile for a particular customer. The advertising management system can include at least one scoring module adapted to analyze at least one marketing profile for a particular customer in order to determine a marketing score for the customer. The advertising management system may determine, based on the marketing profile, advertising and/or marketing content that should be displayed on a display apparatus to the particular customer via, for example, a closed-circuit television system. The advertising management system may provide a comparison of a plurality of marketing profiles associated with a plurality of customers. The advertising management system can be adapted to select and provide advertising and/or marketing content based on which customer or customers is likely to be influenced by the provided content into making one or more purchases.

In an embodiment, a computer-implemented method of creating and/or displaying customer specific advertising content is disclosed herein. The method may include receiving and organizing a plurality of customer specific, demographic, and business or product specific information relating to a particular customer or business. The method can include comparing received information to a plurality of marketing profiles in order to determine a marketing profile for a particular customer, particularly while the customer is onsite at a commercial business. The method may score at least one marketing profile for a particular customer in order to determine a marketing score for the customer. The method can then use the marketing score to determine advertising and/or marketing content that may be displayed to the particular customer. The method can also compare a plurality of marketing profiles associated with a plurality of customers. The method may select and provide advertising and/or marketing content based on which customer or customers are likely to be influenced by the provided content into making one or more purchases.

The above summary of the various representative embodiments of the invention is not intended to describe each illustrated embodiment or every implementation of the invention. Rather, the embodiments are chosen and described so that others skilled in the art may appreciate and understand the principles and practices of the invention. The figures in the detailed description that follows more particularly exemplify these embodiments.

### BRIEF DESCRIPTION OF THE DRAWINGS

FIG. 1 depicts a method and system for creation of customer specific advertisement according to various aspects of the present invention.

FIG. 2 depicts a block diagram of one embodiment of an advertising management system according to various aspects of the present invention.

FIG. 3 depicts an exemplary embodiment of a marketing scoring system according to various aspects of the present invention.

FIG. 4 depicts a flowchart of one embodiment of a method of providing customer specific advertisements according to one aspect of the present invention.

### DETAILED DESCRIPTION OF THE INVENTION

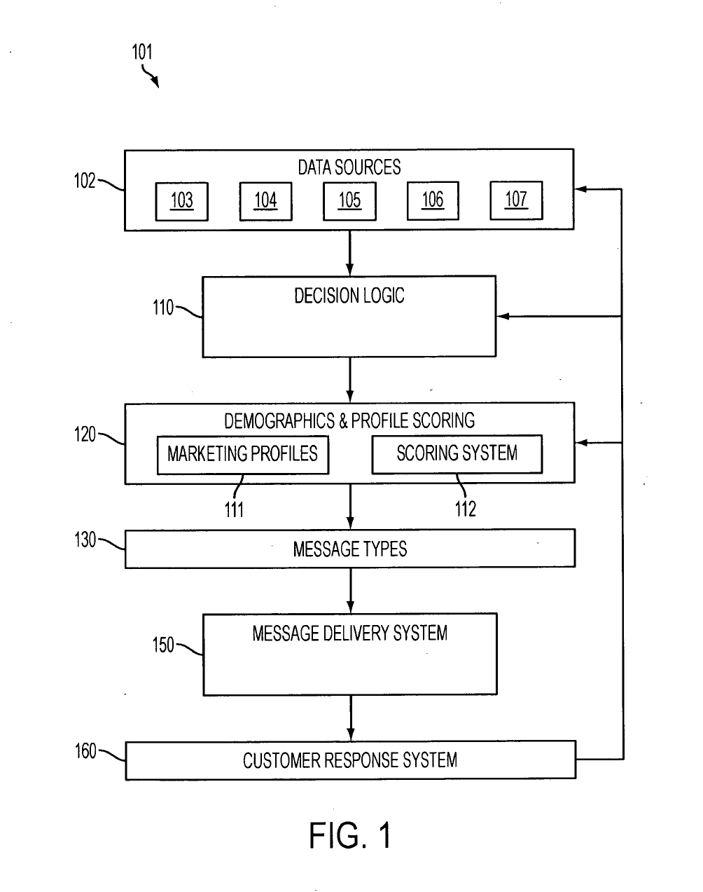

FIG. 1 depicts a flow chart diagram of one embodiment of an advertising management system 101 according to an embodiment of the present invention. Advertising management system 101 has available to it various data source information 102.

Data source information 102 may include manufacturer/business customer records 103. Business records 103 of, for example, a car dealership, may include such information as what type of automobile is owned by the customer, or what amenities the automobile has, such as, for example, type of stereo included in the car, the make or model of tires typically sold with the car, or whether the car has heated seats.

Data source information 102 may also include Customer Records Management (CRM) information 104. CRM information 104 may include personal information specific to the customer, such as the customer's home address, email address, place of employment, profession, or hobbies and/or activities. Customer records can also include information provide by employees of a business or a related business, such as an account manager, as to what types of marketing has worked to influenced particular customers or demographic types into making purchases. Customer records can further include the “click behavior” of a customer on a business's or other website. The “click behavior” of a customer refers to the web pages and items that a customer's behavior on the internet indicates that the customer is interested in.

Data source information 102 may also include Dealer Management System (DMS) inventory records information 105. DMS inventory records information 105 may include information such as what goods and/or services the particular business has available to it, such as what tires an automobile repair shop carries or what line of beauty products a salon offers.

Data source information may further include parts records 106. Parts records 106 may include those particular goods and/or services that the business has available to offer at a particular time, such as what type of employee is available to do a particular type of work, or what products are in stock in the store room at the business that can be sold and provided immediately to a customer.

Data source information may further include information 107 stored by a provider of advertising management system 101. Such information 107 may include information collected from a plurality of businesses that employ advertising management system 101 in order to better predict goods and/or services a particular customer may be interested in.

Advertising management system 101 may also include decision logic 110. In various embodiments, decision logic 110 can be adapted to determine, based at least in part on data source information 102, what particular advertisements should be displayed to particular customers present at a business at a given time. For example, at a car dealership decision logic 110 may determine that it has been a substantial amount of time since a particular customer received an oil change. If that customer is waiting at an automobile service business while brake pads are being changed, decision logic 110 may determine that an advertisement offering discount oil changes may remind the customer of the need to change the oil in his or her car.

Decision logic 110 can also utilize demographic and profile scoring information 120 in determining which ads to display. Demographic information can include marketing profiles 111 that can be matched to particular customers based on data source information 102. Demographic information 120 may include, for example, whether the customer is male or female, or whether the customer is of a particular age group. Demographic information 120 may further include other information such as: the current season, geographical location of the customer or the business, what advertisements and/or offers are available including manufacturing incentives, the current inventory of the business, or the current services available from the business. In other embodiments, marketing profiles 111 may be based on customer specific information.

Demographics and profile scoring information 120 can further include profile scoring system 112. Decision logic 110 may use profile scoring system 112 to determine, based at least in part on marketing profile 111 and/or data source information 102, a likelihood that a particular customer would be interested in a particular product, or whether the customer is likely to be interested in purchasing additional goods and/or services. In another embodiment, profile scoring system 112 may be adapted to compare marketing profiles 111 for multiple customers in order to determine what advertising or marketing materials will provide the greatest potential yield for the business.

Advertising management system 101 can have available to it a variety of message types 130 related to a plurality of different goods and/or services. For example, in a automobile sales or repair business context, message types may fall under categories such as parts, services and new and used cars. Parts message types may include products such as: automobile sound systems, satellite radio service, automobile tires or batteries, child safety seats, membership in an automobile service club such as AAA, environmentally friendly products such as cleaning solutions or products that reduce pollution, or air filters. Services message types 130 may include services such as brake repair, cleaning services such as detailing or undercoating, fluid replacement services such as oil change or transmission fluid replacement services, tire rotation services, tune up services, insurance offers, or financing solutions. New and used car message types may include new automobile models that recently became available, financing offers such as lease specials or other purchase financing offers, or used car inventory specials.

Advertising management system 101 can further include a message delivery system 150, such as a display or other electronic means, to convey the selected message types 130 to consumers. In various embodiments, the electronic means may include: audio communication, a video display such as an LCD, plasma, or other monitor, or printed advertising or marketing materials that are manually or otherwise distributable. In an embodiment, the information conveyed to customers occurs while the customers are in or near the facilities of the business, such as in a waiting room or within a store, or outside or proximate a given business, such as along a street or in a mall. Message delivery means 150 can also include a means for scheduling a timing and order of message delivery. Message delivery means 150 can also be a product of the customer, such as a PDA or cell phone. Advertising management system 101 can stream a selected message wirelessly to a PDA, cell phone, or the like. Access to a customer's wireless device and/or email account can be previously granted by the customer or can be requested at the time the message is delivered.

Advertising management system 101 may also include a system 160 for a customer to respond to a particular advertisement or marketing material. In various embodiments, a customer may be provided the ability to purchase or receive coupons or other printed offers for goods and/or services at the location or by providing an email address. In one embodiment, a touch screen display apparatus is provided to the consumer. In another embodiment, the consumer may use a personal electronic device such as a cellphone, smartphone, or Personal Digital Assistant (PDA). In another embodiment, the customer is provided contact information by which they may further inquire as to a particular good and/or service, or which they may use to order the particular good and/or service. Information received from customer response system 160 regarding customer preferences, etc., can then be fed back into data sources 102, decision logic 110, and/or demographics and profile information 120 to further refine and increase the accuracy and quality of advertising management system 101.

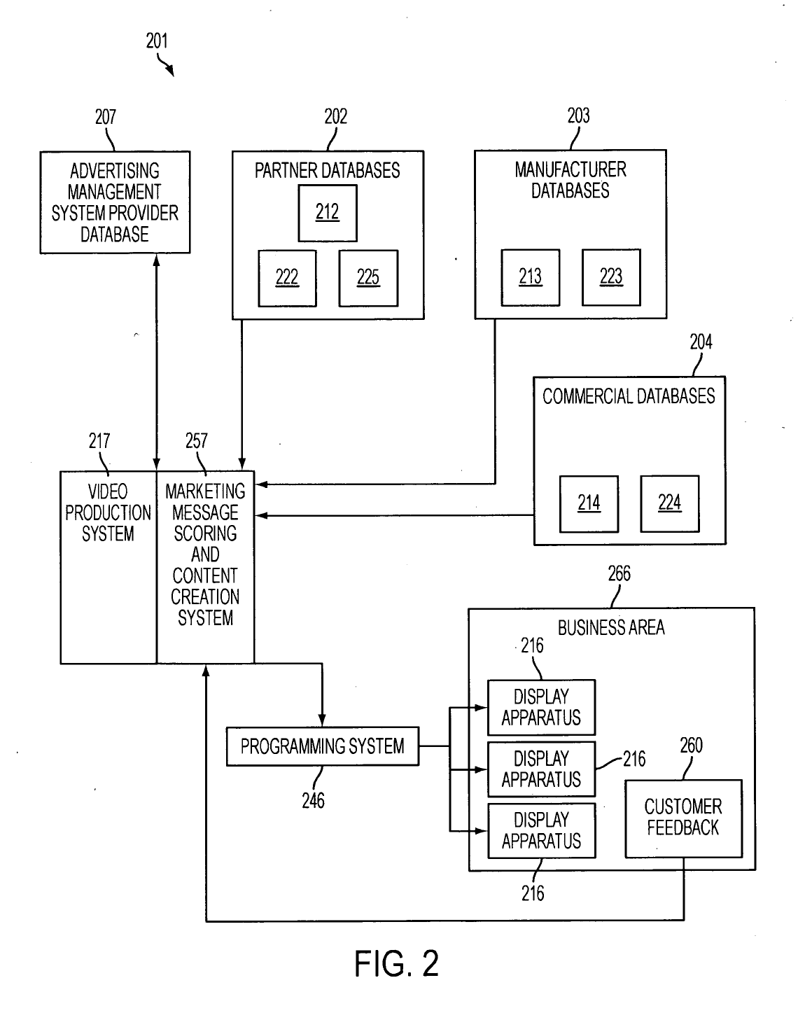

FIG. 2 illustrates generally a block diagram of one embodiment of an advertising management system 201 according to various aspects of the invention described herein. Advertising management system 201 can include one or more areas of a business 266, such as, for example, a customer common area such as a customer waiting room. Business area 266 may also be other common areas of a commercial establishment or any other areas where it is likely that potential consumers will be reached by advertising or marketing materials. Business areas 266 can also include areas where only one customer may be present. Business areas 266 can include one or more display apparatuses 216 capable of conveying a visual image to customers. In one embodiment, displays 216 are adapted to convey video images to customers. In another embodiment, displays 216 are adapted to convey other visual information such as a still photograph or other still image that is not a video. Displays 216 can be communicatively coupled to programming system 246. Programming system 246 can be adapted to control the display of visual images conveyed through displays 216. Displays 216 can also receive programming from a streaming server.

Advertising management system 201 may include one or more partner databases 202, manufacturer databases 203, advertising management system provider database 207 or commercial business databases 204. In one embodiment, commercial business databases 204 include customer records management database 224. Customer records management database 224 may include information such as purchases customers have made in the past, potential purchases the customer may have expressed an interest in, or personal customer information such as name, contact information, occupation, interests, family relationships with other customers, or any other information that a commercial business may have about customers. Commercial business databases 204 may further include Dealer DMS database 214. Dealer DMS database 214 may include information such as what items or services the commercial business has to offer. Dealer DMS database 214 may further include service records for a particular product owned or maintained by a customer. Commercial business databases 204 can also include information provided by employees of one or more businesses, such as an account manager, regarding the as to what types of marketing has worked to influenced particular customers or demographic types into making purchases.

Manufacturer databases 203 can include a manufacturer's customer profile database 213. Manufacturer's customer profile database 213 may include information known by a manufacturer about a particular consumer or group of consumers. Manufacturer databases 203 may also include a manufacturer's specification database 223. Manufacturer's specification database 223 may be adapted to store information related to products that a particular manufacturer has to offer to customers.

Partner databases 202 may be operated by people or businesses separate from the provider of advertising management system 201 and separate from the business itself. Partner database 202 may include databases such as an external content database 212 which may include one or more videos or images relating to the products or services of business. Partner databases 202 may further include publicly available (perhaps with a fee) databases 222 such as a VIN information database. VIN information database may provide information related to a history of an automobile. Partner databases 202 may further include one or more databases of marketing information 225. Such databases may include demographic marketing information such as for a particular age group or income bracket, or may include customer specific marketing information such as purchasing habits or tendencies.

Video production system 217 may be an automated or semi-automated video production system, such as is described in U.S. patent application Ser. Nos. 11/753,412 and 11/999,523, which are incorporated by reference herein in their entirety except of the claims therein. Video production system 217 may be adapted to rapidly provide a professional quality advertising video based at least in part on data stored in advertising management system provider database 207, partner databases 202, manufacturing databases 203, and dealer databases 204. Advertising management system provider database 207 can be maintained by the provider of the advertising management system 201 and can include advertising and marketing materials previously created or compiled by the provider for the business or other business.

Video production system 217 can provide a video that is comprised of a plurality of pre-recorded video elements assembled to run together as a single video. The video can be customized for the particular audience by selecting video elements at least in part based on the information contained in advertising management system 201 regarding the customers to whom the video is going to be presented. Selected video elements can comprise distinct and independent advertisements or other video presentations.

In various embodiments, advertising management system 201, video production system 217, programming system 246, and various databases discussed herein are implemented using one or more computer systems. According to these embodiments, these systems and databases may be adapted to communicate over a network such as the Internet. In one embodiment, these systems and databases are adapted to communicate according to a server-client relationship, or according to a peer to peer relationship. It is to be understood that the various components discussed herein may be implemented according to any physical location or networking implementation, and that any variation on the implementation of such a system is within the scope of the invention described herein.

Advertising management system 201 may further include waiting room marketing scoring system 257. Marketing scoring system 257 may be adapted to accumulate, organize, and compare various information relating to particular customers as well as demographic marketing information relating to one or more particular demographic groups. Marketing scoring system 257 may also be adapted to compare such information with various product or service information and available advertising material in order to determine what video content to display on display means 216 in common areas 266.

Advertising management system 201 may also incorporate a customer feedback system 260. Responses regarding the interest of customers in the various products and services selected to be displayed can be fed back in to the marketing message scoring system 257 to further refine the selection of information to be displayed.

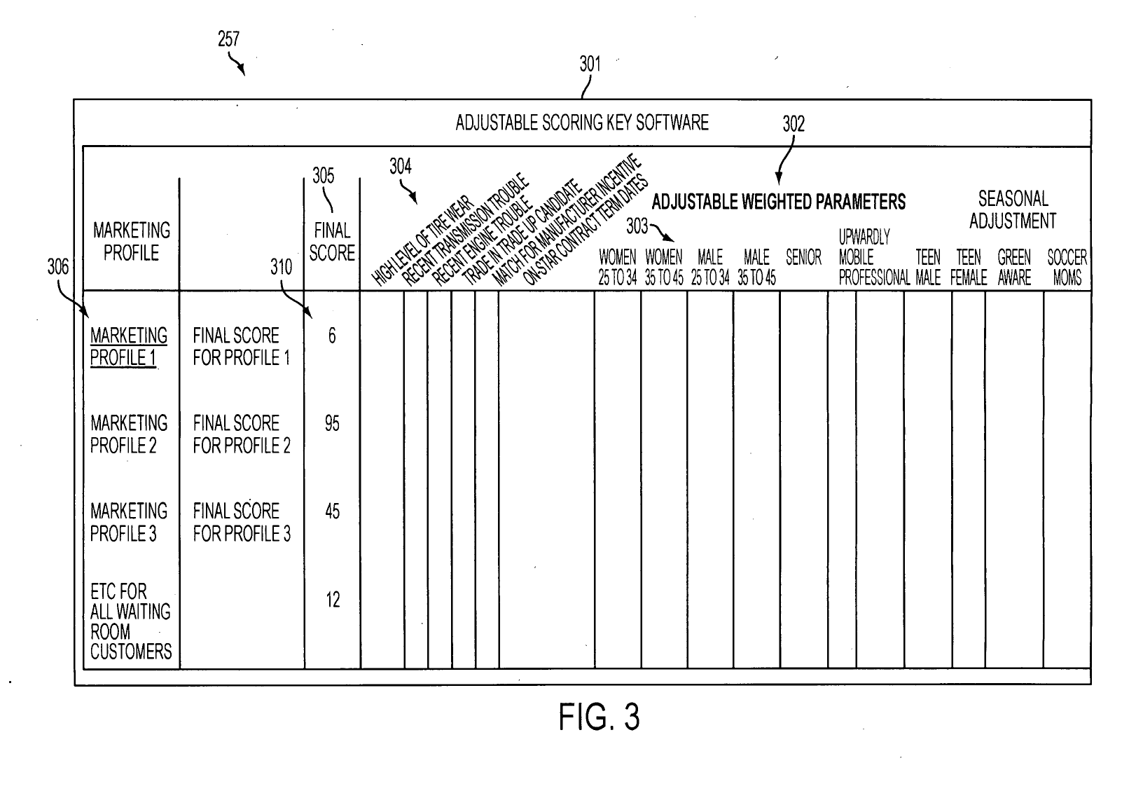

FIG. 3 illustrates a marketing scoring system 257 according to one embodiment of the present invention. Marketing scoring system 257 may include a scoring module 301. Scoring module 301 may include a variety of adjustable weighted parameters 302 containing information that pertains to one or more particular customers or demographic groups. In various embodiments, these parameters may be adjustably weighted such that a user, or the system itself, may place particular importance in scoring on one or more parameters.

Adjustable weighted parameters 302 may include a variety of product parameters 304. In an automobile context as depicted in FIG. 3, product specific parameters 304 can include: level of tire wear, whether the automobile has had recent transmission trouble, whether the customer is a likely candidate to trade in his/her current automobile, whether the customer might qualify for a manufacturing incentive, or whether the customer has an expiring membership to an automobile services contract such as On-Star or satellite radio.

In addition to product specific parameters, adjustable weighted parameters 302 can include demographic parameters 303. Demographic parameters 303 can include, for example age, sex, whether the customer is an upwardly mobile professional, whether the user is a teen male or female, whether the customer is environmentally conscious, and whether the customer is a “soccer mom.” Additionally, demographic parameters 303 may include seasonal parameters, such as whether it is summer or winter (which for example may be used to determine whether to advertise a boat or a snowboard), or event specific seasonal parameters (which for example may be used for event specific advertising, e.g. advertising a big screen TV special the week before the Super Bowl).

In various embodiments, the parameters discussed above are adjustable in order to yield the greatest benefit to advertisers. For example, adjustments may be made based on: the availability of parts and services, dealer inventory, manufacturer or dealer sales incentives, seasonal factors, geographic factors, business or dealership type, local or customer specific vehicle history, demographic trends, seasonal maintenance requirements, or any other factors that tend to influence customer buying habits and/or needs.

Scoring module 301 may be adapted to acquire information from the variety of data sources discussed above with respect to FIG. 2, organize that information, and determine a marketing profile 306 for each particular customer. Marketing profiles 306 can pre-exist on the provider's system and can be selected based on the profile that is most similar to the information known about the customer. Each marketing profile is then assigned a marketing score 310 that may be compared to other customer's marketing scores to determine an estimated affect that advertising to each customer may have, and to determine the optimal advertisements to display to a particular group of customers in a particular waiting room. In the example of FIG. 3, marketing profiles for three customers have been analyzed by scoring module 301. Final score column 305 illustrates that, in this example, marketing score 310 associated with customer 2 has been scored the highest of three customers, meaning that customer 2 is most likely to be influenced into making some kind of purchase by the available advertisements. Therefore, advertising content directed more to customer 2 can be prepared and displayed in this particular waiting room.

In various embodiments, a plurality of marketing profiles which include a variety of demographic information, and corresponding fields, are available to adjustable scoring module 301. According to these embodiments, customer information is compared to the variety of demographic fields and a closest match is selected for the customer.

In various embodiments, adjustable scoring module 301 is adapted to perform the above mentioned comparisons to determine a customer marketing profile and to rank customer scoring profiles based at least in part on times when a customer leaves or enters a particular waiting room or how long a customer is expected to be in the proximity of the advertising message. Thus, advertising content is continually updated to best influence customer behaviors for the customers most likely to be present so as to receive the advertising content.

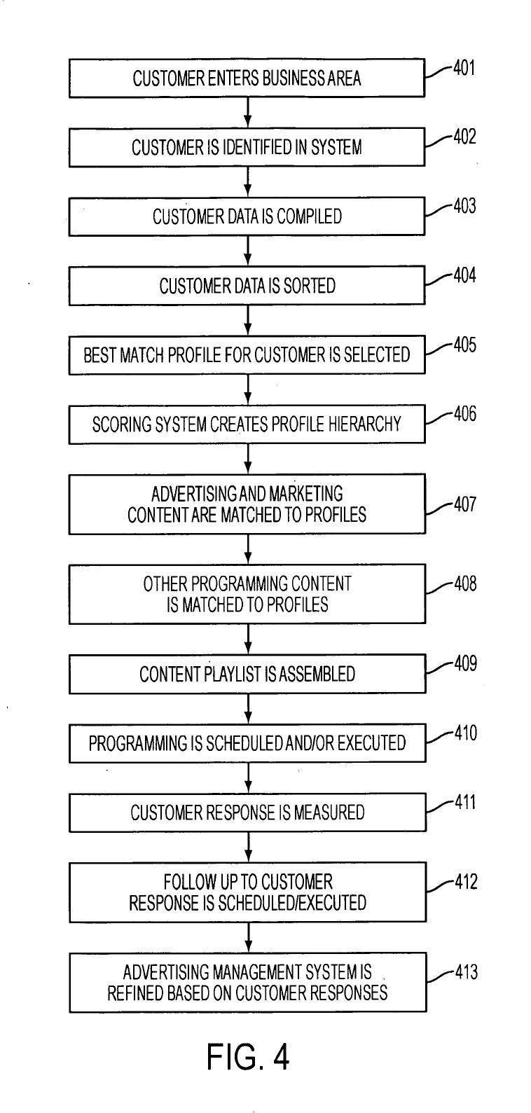

FIG. 4 illustrates generally a flow chart diagram of one embodiment of steps taken by an advertising management system according to various aspects of the invention described herein. At step 401, a customer arrives at a business. The customer may have scheduled an appointment with the business. In another embodiment, a customer does not schedule an appointment, and merely shows up at a business to request a good and/or service. At step 402, the customer checks in with the business and is identified. At step 403 information regarding the customer is retrieved from the various databases available to advertising management system. At step 404, advertising management system sorts the received information, including customer history data such as equipment records and manufacturer customer records. Customer data can be sorted in such a way that it can be matched with predetermined demographic marketing profiles stored by advertising management system. As described in more detail below, the marketing profiles are based on which emotional drivers and ad/sales messages are most likely to influence customer behavior.

At step 405, advertising management system compares the customer information to one or more of the predetermined and adjustable marketing profiles in order to determine a “best match” marketing profile for the customer. The selected profile for the customer is then scored by the scoring system. In one embodiment, the scoring system evaluates possible product upsells, service upsells, trade in scenarios, in view of the marketing profile and the inventory of products and services available to the business. Each profile's score is based on the likelihood of the customer choosing to make a purchase.

At step 406, scoring system creates a hierarchy of the customer profiles for all customers present at the business in order to determine the advertising content that will yield the best results for a particular group of customers. For example, scoring system may compare the profiles of customers that are currently in a waiting room to determine which customer or customers are most likely to be affected by advertising material. In another example, scoring system may compare profiles of customers to determine which customer or customers likely have the most disposable income and are thus more likely to make a purchase. Advertising and marketing materials will then be directed more towards those customers determined most likely to make a purchase. In another embodiment, materials may be selected based on the greatest number of customers determine to be likely to have some level of interest in a particular product or service. In still another embodiment, various combinations of these selection factors may be automatically and dynamically weighted by the scoring system.

At step 407, advertising management system matches the results of the one or more customer profiles selected at step 405 and the comparison of customer profiles at step 406 with available or readily generated advertising materials. At step 408, advertising management system may further determine whether non-advertising materials, such as educational entertainment or licensed video productions should be displayed. In one embodiment, non-advertising materials that may be appealing to one or more customers in the waiting room are selected for display. At step 409, advertising management system creates a playlist for display in the business area and communicates the playlist to the programming system or server. In one embodiment, the playlist may be formatted to include advertising material breaks in non-commercial material similar to the format typically used in broadcast television. In various embodiments, the playlist further includes information such as a stream parameter type or a form factor for display and/or communication of video content.

At step 410, the playlist may be displayed to the customers on one or more displays. At step 411, feedback is received from one or more of the customers viewing the displayed advertising content. In one embodiment, display includes a touch sensitive screen allowing the customer to respond to the advertising content. In one embodiment, the touch screen allows a customer to initiate a purchase or to schedule an appointment. In another embodiment, the customer is provided the ability to talk with a representative, such as a service manager, in order to respond to the advertising content. In another embodiment, the customer is provided the ability to respond to the advertising content using a personal electronic device such as a Personal Digital Assistant (PDA), a cellular phone, a laptop, or any other communication device. In yet another embodiment, the customer is provided contact information such that the customer may respond to the advertising content at a time and/or place other than the waiting room.

At step 412, advertising management system may be adapted to follow up with a customer who expressed interest in a particular product or service. Follow up can include, for example, communication of coupons, a confirmation email, or other follow up marketing. At step 413, the customer responses to the provided advertising content are used to further refine one or more processes for determining a customer profile, performing comparisons, or selection of advertising content as described herein.

As noted above, the marketing profiles to which customers are matched are based on the emotional drivers and regular buying habits that influence a customer to make a purchase. Some considerations that can be taken into account in the automobile context include: expense avoidance motivations, including future return on investment by avoiding repair expenses and dependability, return on investment motivations, including gas mileage and resale value, safety motivations, including family and personal safety, time motivations, including time wasting avoidance and hassle avoidance, social status motivations, current vehicle frustration motivations, including problems occurring and repairs needed for a current vehicle, new feature motivations, such as a desire to have the latest and greatest new features, family image motivations and professional status motivations.

In a further embodiment, customized advertising content can be displayed where only a single customer at a time is expected. For example, advertising content can be displayed at a gas pump while a customer fills a vehicle with gas. The customer's identity can be ascertained from a credit card swiped at the pump. Video elements can be selected to present advertisements and/or other information the customer is likely to be interested in based on what can be learned about the customer from the name on the credit card.

In another embodiment, customized advertising can be customized for an individual customer at a business and can be sent to a portable device possessed by the customer, such as a PDA or cell phone. The customer can be identified and advertising and marketing material that may interest the customer selected as described herein. The selected advertising or marketing material can be sent to the customer wirelessly and accessed by the customer through an email, a pop-up message, or other means. In one embodiment, feedback in the form of the customer opening and viewing an advertisement in a message can be used as an indication that the advertisement type and/or customer are more likely to make a purchase. In a further embodiment, content can be sent to a customer based on the customer's proximity to a product as determined by a sensing means, such as an RFID tag. In this embodiment, when the advertising management system determines based on the sensing means that a customer has stopped near a product, it can deliver an advertising/marketing message related to the particular product to the customer's mobile device.

The above description of the disclosed embodiment is provided to enable any person skilled in the art to make or use the invention. Various modifications to these embodiments will be readily apparent to those skilled in the art, and the generic principles described herein can be applied to other embodiments without departing from the spirit and scope of the invention which is limited by nothing other than the appended claims.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims for the present invention, it is expressly intended that the provisions of Section 112, sixth paragraph of 35 U.S.C. are not to be invoked unless the specific terms “means for” or “step for” are recited in a claim.

1. A computer-implemented method of displaying advertising or marketing content to one or more customers comprising:
identifying a customer present in an area of a business where advertising or marketing content is to be displayed;
automatically accessing customer-specific information related to the customer;
selecting one or more items of advertising or marketing content to be displayed to the customer based on the customer-specific information; and
automatically displaying the one or more items of advertising or marketing content to the customer on a display apparatus located in the area of the of the business.

2. The method of claim 1, wherein accessing customer-specific information includes retrieving the customer-specific information from at least one database.

3. The method of claim 1, wherein accessing customer-specific information includes receiving customer-specific information from the customer.

4. The method of claim 1, further comprising utilizing the customer-specific information to select a marketing profile that best fits the customer from a predetermined database of marketing profiles and wherein selecting one or more items of advertising or marketing content selects the items based on the marketing profile.

5. The method of claim 4, wherein selecting one or more items includes selecting the items by comparing an inventory of products and services available to the business to the marketing profile and selecting items relating to products and services that the customer is most likely to be interested in purchasing based on the customer's marketing profile.

6. The method of claim 1, further comprising identifying additional customers present in the area and accessing customer specific information related to each customer.

7. The method of claim 6, further comprising utilizing the customer-specific information for each customer to select a marketing profile that best fits each customer from a predetermined database of marketing profiles and wherein selecting one or more items of advertising or marketing content selects the items based on the marketing profiles.

8. The method of claim 7, further comprising creating a hierarchical ranking of the marketing profiles for each customer by comparing each profile to an inventory of products and services available to the business and assigning a score to each customer based on a likelihood that each customer will be interested in purchasing one or more of the products and services based on the customers' marketing profiles.

9. The method of claim 8, wherein selecting the one or more items includes selecting the items based on the one or more customers having the highest scores.

10. The method of claim 8, further comprising removing a customer from the hierarchical ranking when it is determined that the customer has left the area.

11. A computer-based system for determining a display of advertising or marketing content to one or more customers present at a business, comprising:
one or more information databases containing information related to one or more of the customers;
a provider database including a plurality of advertising and marketing content;
a scoring system configured to select one or more items of advertising or marketing content from the provider database to be displayed to the one or more customers based on the information related to the one or more customers; and
display means for displaying the advertising and marketing content selected from the provider database.

12. The system of claim 11, further comprising a profile database including a plurality of customer marketing profiles and wherein the scoring system is further configured to compare the information for the one or more customers to the profile database to determine a marketing profile applicable to each of the one or more customers and to select the one or more items of advertising or marketing content based on the one or more marketing profiles.

13. The system of claim 12, wherein the scoring system is further configured to determine a score for each of the one or more marketing profiles based on the likelihood that the customer will be interested in purchasing one or more products and/or services from the business and to create a ranking of the one or more scores.

14. The system of claim 11, wherein the information related to at least one customer was previously stored in the one or more information databases.

15. The system of claim 11, wherein the information related to at least one customer was obtained after the customer entered the business.
